(19) United States
(12) Patent Application Publication
(10) Pub. No.: US 2018/0247443 A1
(43) Pub. Date: Aug. 30, 2018

(54) EMOTIONAL ANALYSIS AND DEPICTION IN VIRTUAL REALITY

(71) Applicant: International Business Machines Corporation, Armonk, NY (US)

(72) Inventors: Benjamin D. Briggs, Waterford, NY (US); Lawrence A. Clevenger, Rhinebeck, NY (US); Leigh Anne H. Clevenger, Rhinebeck, NY (US); Christopher J. Penny, Saratoga Springs, NY (US); Michael Rizzolo, Albany, NY (US); Aldis G. Sipolins, New York City, NY (US)

(21) Appl. No.: 15/445,335

(22) Filed: Feb. 28, 2017

(51) Int. Cl. G06T 13/20; G10L 15/26; G10L 25/63; G10L 13/08; G06T 13/40; G06K 9/00

(52) U.S. Cl. CPC G06T 13/205; G10L 15/265; G06K 9/00302; G10L 13/08; G06T 13/40; G10L 25/63

(57) ABSTRACT

Embodiments of the invention are directed to computer-implemented methods, computer systems, and computer program products for customizing a virtual reality avatar. The method includes receiving inputs from an electromyography sensor. The inputs from the electromyography sensor include inputs derived from the activity or inactivity of facial muscles. In some embodiments, the electromyography sensor is integrated into a head mounted display to be in contact with a user's facial muscles. The inputs from the electromyography sensor are translated into data that represents sensed facial expressions. The facial features of the user's virtual reality avatar are modified based at least in part on the data that represents sensed facial expressions.

### BACKGROUND

The present invention relates in general to the field of computing. More specifically, the present invention relates to systems and methodologies for emotional analysis and depiction in a virtual reality environment.

Virtual reality refers to computer technologies that use software to present different images to each eye to simulate natural human vision. Virtual reality comprises images, sounds, and other sensations that replicate a real environment and simulate a user's physical presence in the environment. A typical virtual reality setup uses special hardware (such as a headset, also known as a head-mounted display (HMD)) that is worn by the user to more fully immerse the user in a virtual reality environment. Sensors in the HMD monitor the user's movements such that, when the user moves, the images shown in the HMD change to track the user's movement.

### SUMMARY

Embodiments of the present invention are directed to a computer-implemented method of customizing a user's virtual reality avatar. The method includes receiving inputs from a sensor. The inputs from the sensor include inputs derived from the activity or inactivity of the user's facial muscles. The inputs from the sensor are translated into data that represents sensed facial expressions of the user. Based at least in part on the data that represents sensed facial expressions of the user, one or more facial features of the user's virtual reality avatar are modified.

Embodiments of the present invention are further directed to a computer system for customizing a user's virtual reality avatar. The computer system includes a memory and a processor system communicatively coupled to the memory. The processor system is configured to perform a method that includes receiving inputs from a sensor. The inputs from the sensor include inputs derived from the activity or inactivity of the user's facial muscles. The inputs from the sensor are translated into data that represents sensed facial expressions of the user. Based at least in part on the data that represents sensed facial expressions of the user, one or more facial features of the user's virtual reality avatar are modified.

Embodiments of the present invention are further directed to a computer program product for customizing a user's virtual reality avatar. The computer program product includes a computer-readable storage medium having program instructions embodied therewith. The program instructions are readable by a processor system to cause the processor system to perform a method that includes receiving inputs from a sensor. The inputs from the sensor include inputs derived from the activity or inactivity of the user's facial muscles. The inputs from the sensor are translated into data that represents sensed facial expressions of the user. Based at least in part on the data that represents sensed facial expressions of the user, one or more facial features of the user's virtual reality avatar are modified.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter that is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a head-mounted display of an exemplary embodiment;

FIG. 2 depicts a flow diagram illustrating the operation of an exemplary embodiment;

FIG. 3 depicts a computer system capable of implementing hardware components of one or more embodiments; and

FIG. 4 depicts a diagram of a computer program product according to one or more embodiments.

### DETAILED DESCRIPTION

Various embodiments of the present invention will now be described with reference to the related drawings. Alternate embodiments can be devised without departing from the scope of this invention. Various connections might be set forth between elements in the following description and in the drawings. These connections, unless specified otherwise, can be direct or indirect, and the present description is not intended to be limiting in this respect. Accordingly, a coupling of entities can refer to either a direct or an indirect connection.

Additionally, although a detailed description of a computing device is presented, configuration and implementation of the teachings recited herein are not limited to a particular type or configuration of computing device(s). Rather, embodiments are capable of being implemented in conjunction with any other type or configuration of wireless or non-wireless computing devices and/or computing environments, now known or later developed.

Furthermore, although a detailed description of usage with specific devices is included herein, implementation of the teachings recited herein are not limited to embodiments described herein. Rather, embodiments are capable of being implemented in conjunction with any other type of electronic device, now known or later developed.

At least the features and combinations of features described in the immediately present application, including the corresponding features and combinations of features depicted in the figures amount to significantly more than implementing a method of showing a user's emotions in a virtual reality avatar. Additionally, at least the features and combinations of features described in the immediately following paragraphs, including the corresponding features and combinations of features depicted in the figures go beyond what is well understood, routine and conventional in the relevant field(s).

While virtual reality is often used in a gaming environment, virtual reality is also being used in social networking applications. Social networking allows users to interact with other users. Currently, typical social networking interactions use text or voice inputs.

A drawback of using virtual reality in social networking is that the avatars (i.e., the graphical representation of each user) are typically expressionless. When people interacting with each other in person, their emotions can be important in determining how they are reacting to each other.

Embodiments of the present invention address the above-described issues by using a novel method and system to allow a user's facial expressions and other indicia of a user's emotions to be detected. Indications of the user's emotions can be embodied in the user's avatar, resulting in a more engaging and interactive experience.

In known virtual reality systems, the HMD obscures the user's face. Embodiments of the present invention integrate special sensor functionality into the HMD to generate data that represents the facial expressions of users. This data can be translated in a real-time basis into facial expressions of the user's virtual reality. Such sensor data can be augmented with voice analysis to monitor the user's emotions. The integrated analysis of facial expressions and speech provides a comprehensive analysis of a user's emotion and engagement.

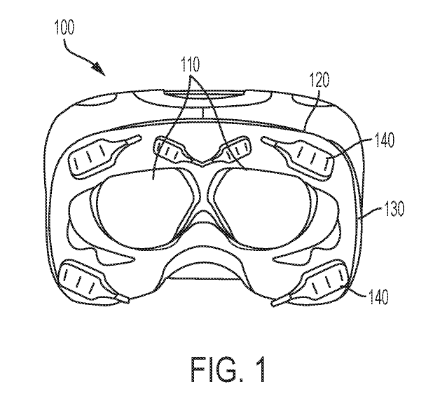

With reference to FIG. 1, an HMD 100 of an exemplary embodiment of the invention is shown. HMD 100 is device that is worn by a user who uses straps (not illustrated) on HMD 100 to secure HMD 100 to the user's head. HMD 100 includes one or more displays 110. In some embodiments, multiple displays can be used. In some embodiments, a single display can be used, with a one portion of the display being configured for a user's left eye and another portion of the display being configured for the user's right eye. There can be a lens or other covering over the one or more displays. Other configurations are possible. Displays 110 are coupled to a computer system (not shown) via a wired connection or a wireless connection. In some embodiments, the one or more displays are coupled to a dedicated graphic card that is coupled to a computer system via a video cable, such as an HDMI cable or a DisplayPort cable. The computer system controls the display of images on displays 110. There can be other connections between a computer system and HMD 100, such as a USB cable and a power cable. HMD 100 typically includes one or more internal sensors (not shown). The internal sensors can include gyroscopic sensors that determine the orientation of HMD 100. In response to movement detected by internal sensors, the images being displayed by display 110 can change. There can be other sensors, such as microphones, as well as outputs, such as a headphone jack. HMD 100 can be used in conjunction with external controllers and sensors that can be controlled, for example, by a user's hands (such as a “wired glove,” gamepad, or other type of controller) or that sense a user's movement within a room. Display 110 is mounted within a housing 120. The housing can contain other features that are not shown, such as straps to allow a user to wear HMD 100, switches and buttons to control the operation of HMD 100, and indicators that indicate a status of HMD 100.

In typical usage, the images being shown to the user can represent an experience that the user is undergoing. For example, the user can be climbing a mountain or walking in a room. With each movement the user makes, display 110 changes such that the user is “immersed” in a virtual reality experience. Content can be created that is specific to a virtual reality environment. For example, instead of merely filming a wild animal on a safari, the filming will be of a 360-degree environment. When viewed using an HMD, a user is able to physically turn around in any direction and see what is happening in that direction.

Virtual reality systems can be used in a social networking environment. Instead of interacting with a pre-recorded material or with the environment, virtual reality social networking involves placing a user in a virtual location with other users who are also in the same virtual location. In such a use case, each user is represented by an “avatar,” which is a computer-generated representation of the user. Therefore, when used in a virtual reality social networking environment, a user can see another user's avatar and speak or otherwise interact with the other user's avatar. Such a social networking use case allows a user to interact with other users while within a virtual reality environment. The virtual reality environment can be real (for example, a conference room), or it can be fanciful (for example, in the middle of outer space). The virtual reality environment can be the point of the interaction with other users (for example, allowing the user to explore an environment with another user), or it can be merely a background (for example, the point of the interaction is to interact with other users).

However, in known applications of virtual reality systems to social networking, a user does not see another user's facial expressions. Therefore, a user cannot see if the other user is smiling or is sad. The user only sees another user's avatar, which is expressionless in known social networking virtual reality applications.

Returning to FIG. 1, embodiments of the invention include sensors 140 in HMD 100. The sensors 140 are configured to track electrical activity produces by skeletal muscles. In some embodiments of the invention, the sensors 140 are implemented as electromyography (EMG) sensors. Mechanical flex sensors also can be used to detect facial movements indicating different expressions. Electrodermal Activity (EDA) sensors could be used to indicate presence of nervousness to contribute to a frown avatar decision. When placed in an appropriate portion of HMD 100, EMG sensors 140 can track the movement of a user's eyebrows, cheek muscles, and jaw muscles. As shown in FIG. 1, EMG sensors 140 can be placed on a foam liner or gasket 130 that surrounds the display 110. In some embodiments, EMG sensors 140 can be mounted in a Kapton tape as a flexible substrate. While six sensors 140 are shown in FIG. 1, it should be understood that any number of sensors 140 can be present in various embodiments.

By tracking the movement of a user's facial muscles, the facial expressions of the users can be determined. Thereafter, the user's avatar can reflect the facial expression of the user. In other words, when the user smiles the user's avatar also smiles. When the user raises his eyebrows, the user's avatar raises his eyebrows. In some embodiments, this can be accomplished by sending the signals from EMG sensors to the virtual reality game engine software operating on a computer to system to which HMD 100 is coupled. The game engine software can process the signal to determine the corresponding facial expression. In some embodiments, some facial expressions are pre-defined. In such an embodiment, when a pre-determined pattern of EMG signals is detected, the pre-defined facial expression (e.g., neutral, smile, frown, mouth open, and the like) is shown in the user's avatar.

In some embodiments of the invention, the virtual reality HMD 100 includes a microphone. In some embodiments, the microphone is internal to housing 120. In some embodiments, an external microphone can be coupled to a microphone jack on housing 120. The microphone can capture a user's speech and the user's avatar can be shown to be speaking when the user speaks. In such a manner, a user can interact with another user in a virtual reality environment.

In some embodiments of the invention, the speech being received by the microphone can be analyzed. The analysis can include a machine-learning algorithm that analyzes the tone of the user. In some embodiments of the invention, a text-to-speech conversion is performed to change the user's speech into text. Thereafter, the text is analyzed using a machine-learning algorithm such the Watson Tone Analyzer. The tone of the user can be used in conjunction with the user's facial expressions to determine the user's emotional state, which is displayed on the user's avatar.

A variety of use cases will now be provided to illustrate technical benefits of showing a user's emotional state in a virtual reality environment. For example, virtual reality interaction can include the interaction between a teacher and a student or between a first student and a second student in a learning environment. If the second student's facial expressions indicate confusion, the first student (or a teacher) can see that the second student is being confused by their interaction. Therefore, the first student (or a teacher) can then offer to provide additional help to the second student. The first student is able to use non-verbal cues in his interactions with the second student, just as he would be able to in a real-world interaction.

Similarly, a system running virtual reality software can adjust what is being shown to a user based on the user's reactions that are detected by the EMG sensors. For example, in a similar situation to that described above, a virtual reality environment can be shown to a user. In a similar manner to that described above, the user's facial reactions and voice interactions can be analyzed to detect if the user's reactions. If the user is bored by a scenario being presented by the virtual reality servers, the environment can be changed (for example, by making the scenario more difficult). If the user is frustrated by a situation being presented by the virtual reality environment, the virtual reality environment can be changed (for example, by making the scenario easier). This can apply to gaming situations or to learning situations.

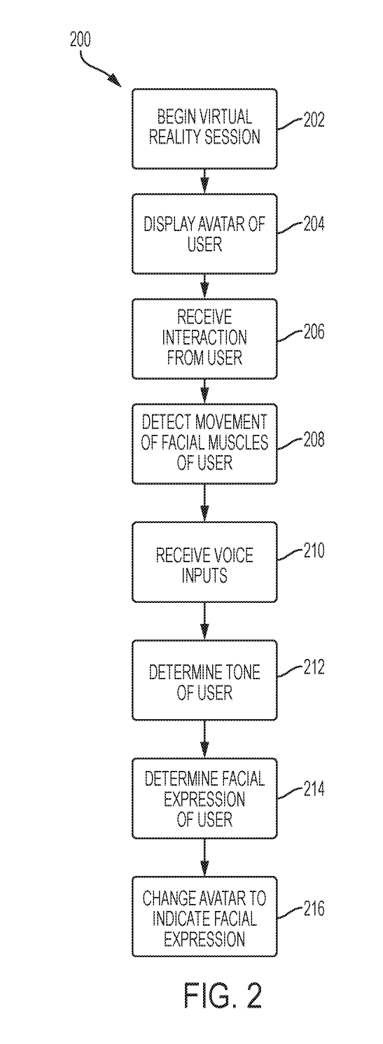

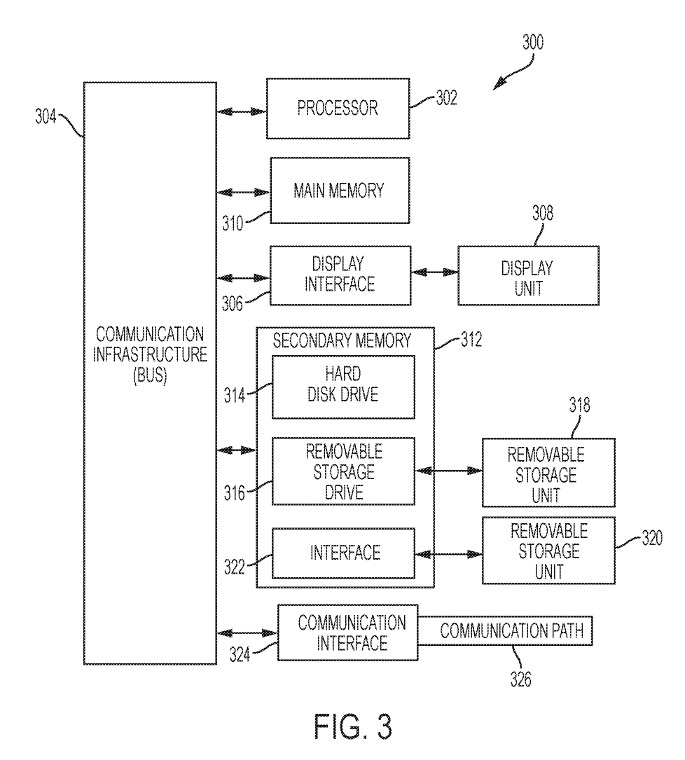

A flowchart illustrating a method 200 according to embodiments of the invention is presented in FIG. 2. Method 200 is merely exemplary and is not limited to the embodiments presented herein. Method 200 can be employed in many different embodiments or examples not specifically depicted or described herein. In some embodiments, the procedures, processes, and/or activities of method 200 can be performed in the order presented. In other embodiments, one or more of the procedures, processes, and/or activities of method 200 can be combined or skipped. In some embodiments, portions of method 200 can be implemented by system 300 (FIG. 3).

Method 200 presents a flow for the updating of a user's avatar. A virtual reality session is begun (block 202). The user places an HMD (such as HMD 100) on his head to as part of the virtual reality session.

The virtual reality session involves the user being placed in a virtual reality environment. An avatar is displayed based on the user (block 204). The creation of the avatar can take place in one of a variety of methods known in the art. For example, a pre-set can be used as the basis for a user's avatar. The creation of a user's avatar is known in the art and can use one or more of a variety of techniques. For example, the avatar's facial features can be chosen along with the clothing of the avatar.

The user interacts with the HMD (block 206). The interaction with 206 can include vocal interactions. The HMD can include a microphone to accept audio input. The HMD also can include one or more EMC sensors. The EMC sensors can be arranged to detect the muscle movements of the user's facial muscles (block 208).

Voice inputs can be translated into text (block 210). The text can be analyzed to determine the tone of the user (block 212). A facial expression for the avatar is generated (block 214). The facial expression can be generated based on a combination of the EMC sensors, the tone sensors, and other sensors. Thereafter, the user's avatar is changed to indicate the facial expression of the user (block 216).

FIG. 3 depicts a high-level block diagram of a computer system 300, which can be used to implement one or more embodiments. More specifically, computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them. Computer system 300 can have one of a variety of different form factors, such as a desktop computer, a laptop computer, a tablet, an e-reader, a smartphone, a personal digital assistant (PDA), and the like.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the forgoing detailed description that one or more embodiments provide technical benefits and advantages.

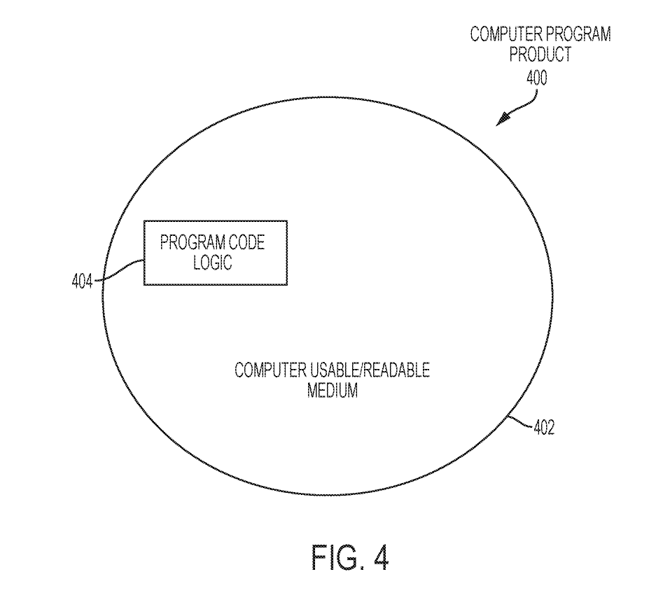

Referring now to FIG. 4, a computer program product 400 in accordance with an embodiment that includes a computer-readable storage medium 402 and program instructions 404 is generally shown.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the consumer's computer, partly on the consumer's computer, as a stand-alone software package, partly on the consumer's computer and partly on a remote computer or entirely on the remote computer or server. In the latter scenario, the remote computer can be connected to the consumer's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The descriptions presented herein are for purposes of illustration and description, but is not intended to be exhaustive or limited. Many modifications and variations will be apparent to those of ordinary skill in the art without departing from the scope and spirit of embodiments of the invention. The embodiment was chosen and described in order to best explain the principles of operation and the practical application, and to enable others of ordinary skill in the art to understand embodiments of the present invention for various embodiments with various modifications as are suited to the particular use contemplated.

What is claimed is:

1. A computer-implemented method for customizing a user's virtual reality avatar, the method comprising:
receiving, by a processor, inputs from an sensor, wherein the inputs from the sensor comprise data that represents activity or inactivity of facial muscles; and
translating, by the processor, the inputs from the sensor to data that represents sensed facial expressions; and
modifying, by the processor, one or more facial features of the user's virtual reality avatar based at least in part on the data that represents sensed facial expressions.

2. The computer-implemented method of claim 1 further comprising:
receiving, by the processor, voice inputs from the user; and
determining, by the processor, a tone of the user from the voice inputs; wherein modifying one or more facial features of the virtual reality avatar comprises using the tone of the user modify the facial features.

3. The computer-implemented method of claim 2, wherein receiving voice inputs from the user comprises using a microphone integrated in a head mounted display (HMD) arranged to be worn by the user to receive voice inputs.

4. The computer-implemented method of claim 1, wherein determining the tone of the user comprises:
converting, by the processor, the voice inputs into text; and
analyzing, by the processor, the text to determine the tone.

5. The computer-implemented method of claim 1, wherein:
modifying one or more facial features of the virtual reality avatar comprises choosing one facial expression for display from a set of facial expressions.

6. The computer-implemented method of claim 1, wherein the sensor is integrated in a head mounted display (HMD) arranged to be worn by the user.

7. The computer-implemented method of claim 6, wherein the sensor is integrated into a gasket that directly contacts the user's face.

8. A computer system for customizing a user's virtual reality avatar, the system comprising:
a memory; and
a processor system communicatively coupled to the memory;
the processor system configured to:
receive inputs from a sensor, wherein the inputs from the sensor comprise data that represents activity or inactivity of facial muscles; and
translate the inputs from the sensor to data that represents sensed facial expressions; and
modify one or more facial features of the user's virtual reality avatar based at least in part on the data that represents sensed facial expressions.

9. The computer system of claim 8 further comprising:
receiving, by the processor, voice inputs from the user; and
determining, by the processor, a tone of the user from the voice inputs; wherein modifying one or more facial features of the virtual reality avatar comprises using the tone of the user modify the facial features.

10. The computer system of claim 9, wherein receiving voice inputs from the user comprises using a microphone integrated in a head mounted display (HMD) arranged to be worn by the user to receive voice inputs.

11. The computer system of claim 8, wherein determining the tone of the user comprises:
converting, by the processor, the voice inputs into text; and
analyzing, by the processor, the text to determine the tone.

12. The computer system of claim 11, wherein:
modifying one or more facial features of the virtual reality avatar comprises choosing one facial expression for display from a set of facial expressions.

13. The computer system of claim 8, wherein the sensor is integrated in a head mounted display (HMD) arranged to be worn by the user.

14. The computer system of claim 13, wherein the sensor is integrated into a gasket that directly contacts the user's face.

15. A computer program product for customizing a user's virtual reality avatar, the computer program product comprising:
a computer-readable storage medium having program instructions embodied therewith, the program instructions readable by a processor system to cause the processor system to perform a method comprising:
receiving inputs from a sensor, wherein the inputs from the sensor comprise data that represents activity or inactivity of facial muscles; and
translating the inputs from the sensor to data that represents sensed facial expressions; and
modifying one or more facial features of the user's virtual reality avatar based at least in part on the data that represents sensed facial expressions.

16. The computer program product of claim 15 further comprising:
receiving, by the processor, voice inputs from the user; and
determining, by the processor, a tone of the user from the voice inputs; wherein modifying one or more facial features of the virtual reality avatar comprises using the tone of the user modify the facial features.

17. The computer program product of claim 16, wherein receiving voice inputs from the user comprises using a microphone integrated in a head mounted display (HMD) arranged to be worn by the user to receive voice inputs.

18. The computer program product of claim 15, wherein determining the tone of the user comprises:
converting, by the processor, the voice inputs into text; and
analyzing, by the processor, the text to determine the tone.

19. The computer program product of claim 15, wherein the sensor is integrated in a head mounted display (HMD) arranged to be worn by the user.

20. The computer program product of claim 19, wherein the sensor is integrated into a gasket that directly contacts the user's face.
